(19) United States
(12) Patent Application Publication
(10) Pub. No.: US 2006/0013739 A1
(43) Pub. Date: Jan. 19, 2006

(54) Portable and mountable liquid or gel dispenser

(76) Inventors: Hector J. Castillo, Mastic, NY (US); Robert A. Musco, Lakewood, FL (US); Barbara A. Musco, Oceanside, NY (US)

Correspondence Address: INTELLECTULAW;LAW OFFICES OF P.B. TUFARIELLO, P.C., 25 Little Harbor Road, Mount Sinai, NY, 11766, US

(21) Appl. No.: 10/388,850

(22) Filed: Mar. 13, 2003

Related U.S. Application Data
(60) Provisional application No. 60/364,965, filed on Mar. 13, 2002.

(51) Int. Cl. B01L 3/02

(52) U.S. Cl. 422/100

(57) ABSTRACT

A mountable, portable, liquid or gel dispensing apparatus provided with mounting means, a reservoir and a pliable button. The mounting means are fixedly attached on the liquid or gel dispensing apparatus and designed for mounting the liquid or gel dispensing apparatus on anything capable of being hooked. The reservoir is housed within the liquid or gel dispensing apparatus. It receives and stores the liquid or gel until the pliable button, which is communicatingly connected to the reservoir, is intentionally actuated to release and dispense the stored liquid or gel.

### CROSS REFERENCE TO RELATED PROVISIONAL APPLICATION

This application claims the benefit of U.S. Provisional patent application No. 60/364,965 filed on Mar. 13, 2002.

### BACKGROUND OF THE INVENTION

1. Field of the Invention

The present invention relates to hand sanitization methods and apparatus. Even more particularly, the present invention relates to a method and apparatus which facilitates the sanitization of hands everywhere and anywhere, on an as needed basis, without any constraints due to time or location.

2. Related Art and Prior Art Statement

It is generally recognized and accepted that the transmission of microbiological pathogens, i.e., germs and bacteria, can make people extremely ill. For example the transmission of microbiological pathogens from hands to other parts of the body or to food is a frequent means of communicating diseases. Some potential pathogens are E. Coli, Salmonella, Shigella, Listeria and Staph. Aureus. These pathogens in contaminated food are responsible for severe illnesses and even death.

Episodes involving fatalities due to contamination of food products during food handling have increased the public's awareness of the potentially serious consequences of improper food handling. However, the contamination of food is not the only source of germs and bacteria that can make people ill. Media reports abound showing how daily contact with germs can lead to illness and even death. Doorknobs, pets, ATM machines, computer keyboards and toys are just some of the culprits that collect microbiological pathogens and reroute them to hands and mouths, from which they are only a short hop to the body's most sensitive systems.

Perhaps the highest increased of the public's awareness of the seriousness of microbiological pathogen contamination occurred during the recent events of the anthrax scare in the United States. Besides the tragic events of Sep. 11, 2001 World Trade Center disasters, nothing has brought closer to home the fact that bacteria and germs can kill in a very fierce and insidious manner.

Of course, washing one's hands with soap and water is the best deterrent against germs. Recommended by the American Association for Microbiology, the Food and Drug Administration, and physicians everywhere, regular and proper washing can prevent people from both receiving and passing on bacteria that cause illnesses, from single infections to severe gastrointestinal disorders and death.

Yet, no matter how much hand washing is stressed, as for example with signs stating “Wash Hands before Leaving Rest Room”, people still fail to properly sanitize their hands; a fact that is further exacerbated when soap and water are inaccessible due to time restraints or location. As a result, many methods, formulations and apparatus have been devised to help remedy the problem. Such methods, range from the very simple to the very complex.

For example, gel or liquid hand sanitizing formulas have been developed as the best bet away from the wash basin. Typically, they are packaged in durable, portable purse or pocket size containers, such as tubes or pumps. They don't replace hand washing. Rather, they provide quick disinfecting when soap and water are not available.

Other examples are the following: hand sanitizing stations using germicidal gels or foams and equipped with infrared, detector-activated, pressurized spray devices designed to spray fluids and readily irrigate, in a fully automated manner, the entire surface of the hands with a special disinfecting fluid, as disclosed in European Patent Application No. 0567678A1 to Mongkol on Nov. 3, 1993; devices for electrostatic spraying of relatively low resistivity liquids such as aqueous and alcohol based liquids as disclosed in U.S. Pat. No. 5,292,067 issued to Jeffries, et. al.; and devices which use at least two electrostatic emitters to dispense germicidal fluid to substantially all the surfaces of a user's hands, when both hands are placed in proximity to the electrostatic emitters as disclosed in U.S. Pat. No. 5,863,497 issued to Derksing et. al. on Jan. 26, 1999.

However, none of these methods and apparatus have solved the real problem with sanitizing hands, i.e., people's failure to clean, wash and sanitize their hands due to constraints of time and location. None of these methods are truly portable and accessible at any time. Little tubs and pumps disappear into the proverbial black holes of bags, drawers, medicine cabinets, pockets and carry-ons. As for the devices disclosed in the prior art patents set forth above, they are just as cumbersome in size, weight, and configuration as other washing and sanitizing mechanisms. Consequently, even though they profess to comprise a solution to the problem, they really do not.

### OBJECTS OF THE INVENTION

Accordingly, it is an object of the present invention to encourage compliance with hand sanitization requirements by providing a hand sanitizing apparatus and method that is simple, convenient and fast to use.

Another object of the present invention is to provide an improved hand sanitizing apparatus which is mountable, portable and immediately accessible without regard to time or location.

It is a further object of the present invention to provide a sanitizing apparatus and method that is designed to provide for the facile elimination of microbiological pathogens, i.e., germs and bacteria, such as E. Coli, Salmonella, Shigella, Listeria and Staph. Aureus and thereby the cessation of illnesses and even death due to such illnesses.

It is still another object of the present invention to encourage people to properly sanitize their hands; irrespective of time restraints or location.

These and other objects will become readily apparent from the detailed description of the invention and the drawings that follow.

### SUMMARY OF THE INVENTION

According to the invention, a hand sanitizing apparatus for applying germicidal agents such as gels, fluids, lotions, creams, ointments or liquid soaps, comprises a relatively rigid, hard inflexible body having a chamber. The chamber functions as a reservoir to hold and store the germicidal agent. The body further comprises an entry port, an exit port, means for mounting the dispenser practically everywhere and anywhere, a dome shaped button which when pressed dispenses an appropriate dose of the germicidal agent, and two check valves, one which permits the refilling of the reservoir through the entry port via a special nozzle, but which does not allow the germicidal agent to flow out, once it is placed in the reservoir; and one at the exit port which allows the delivery of the dose of the germicidal agent, but only after physical pressure is actually applied on the dome-shaped button.

In another embodiment of the invention a hand sanitizing method for applying germicidal agents comprises the steps of filling the reservoir of the dispenser with the germicidal agent using the one-way valve on the top end of the body of the dispenser via a special nozzle; mounting and securing the dispenser on a belt, bag, folder, etc; carrying the dispenser to whatever site the dispenser may be needed; and while the dispenser is still mounted and secured or after removing the dispenser from the belt, bag or folder, pressing on the dome-shaped button to deliver a predetermined dosage of germicidal agent.

### BRIEF DESCRIPTION OF THE DRAWINGS

While the specification concludes with claims which particularly point out and distinctly claim the present invention, it is believed that the present invention will be better understood from the following detailed description taken in conjunction with the accompanying drawings in which like numerals represent identical elements and wherein:

FIG. 1 is a summary of views of one embodiment of the inventive portable and mountable germicidal agent dispenser made and used in accordance with the present invention;

FIG. 2 is a bottom view of one embodiment of the inventive portable and mountable germicidal agent dispenser made and used in accordance with the present invention;

FIG. 3 is a side view of the inventive portable and mountable germicidal agent dispenser shown in FIG. 2;

FIG. 4 is another side of the inventive portable and mountable germicidal agent dispenser shown in FIG. 2, showing the hooking means by which the dispenser is mounted and supported;

FIG. 5 is a cross-sectional side view of the inventive portable and mountable dispenser taken along line A-A of FIG. 3 and showing part of the dome shaped button;

FIG. 6 is a detailed, close-up side view of the inventive portable and mountable germicidal agent dispenser taken along circle C of FIG. 4;

FIG. 7 is a cross-sectional side view of the inventive portable and mountable dispenser taken along line B-B of FIG. 4 showing the internal configuration of the inventive dispenser's reservoir, entry port and exit port;

FIG. 8 is another side view of the inventive portable and mountable germicidal agent dispenser shown in FIG. 2, showing the exit port;

FIG. 9 is a perspective view of the inventive portable and mountable germicidal agent dispenser of FIGS. 2-8.

FIG. 10 is a top view of the inventive portable and mountable germicidal agent dispenser of FIG. 9 showing the entrance port;

FIG. 11 is a perspective of the dome shaped button of the inventive portable and mountable germicidal agent dispenser;

FIG. 12 is a side view of the dome shaped button of FIG. 11;

FIG. 13 is another side view of the dome shaped button of FIG. 11;

FIG. 14 is a cross-section side view of the dome shape button of FIG. 13 taken along line E-E; and

FIG. 15 is a detailed cross-section side view of the outer perimeter of the dome shaped button of FIG. 13 taken along circle F of FIG. 14.

FIGS. 16-27 represent an alternate embodiment of the inventive portable, mountable germicidal agent dispenser.

### List of Elements and their Respective Identifying Numerals

| NO | ELEMENT |
|---|---|
| 10 | hand sanitizing apparatus |
| 12 | germicidal agent |
| 14 | body |
| 16 | top end |
| 18 | bottom end |
| 20 | first side |
| 22 | second side |
| 24 | reservoir |
| 26 | mounting means |
| 26A | first arm |
| 26B | second arm |
| 26C | elbow |
| 26D | radius hook |
| 28 | orifice |
| 30 | dome shaped stopper or plug |
| 32 | flange |
| 34 | channel, groove or notch |
| 36 | Entry port |
| 38 | first cylindrical partial bore |
| 40 | filling or intake valve |
| 42 | Exit port |
| 44 | second cylindrical partial bore |
| 46 | output or exit valve |

### DETAILED DESCRIPTION OF THE INVENTION

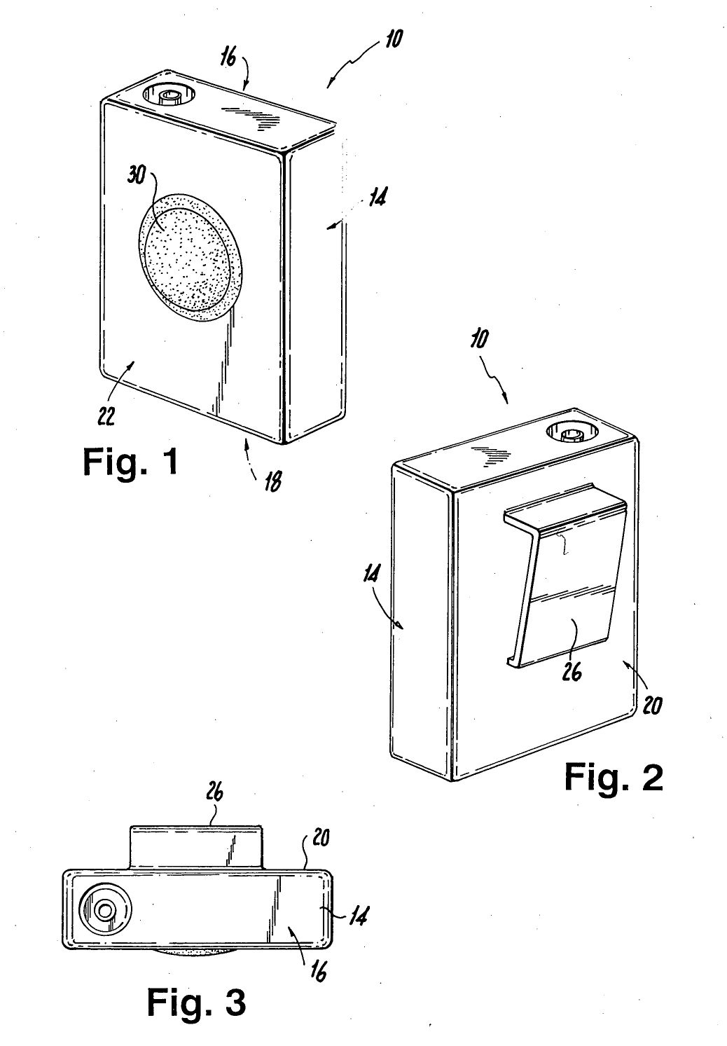

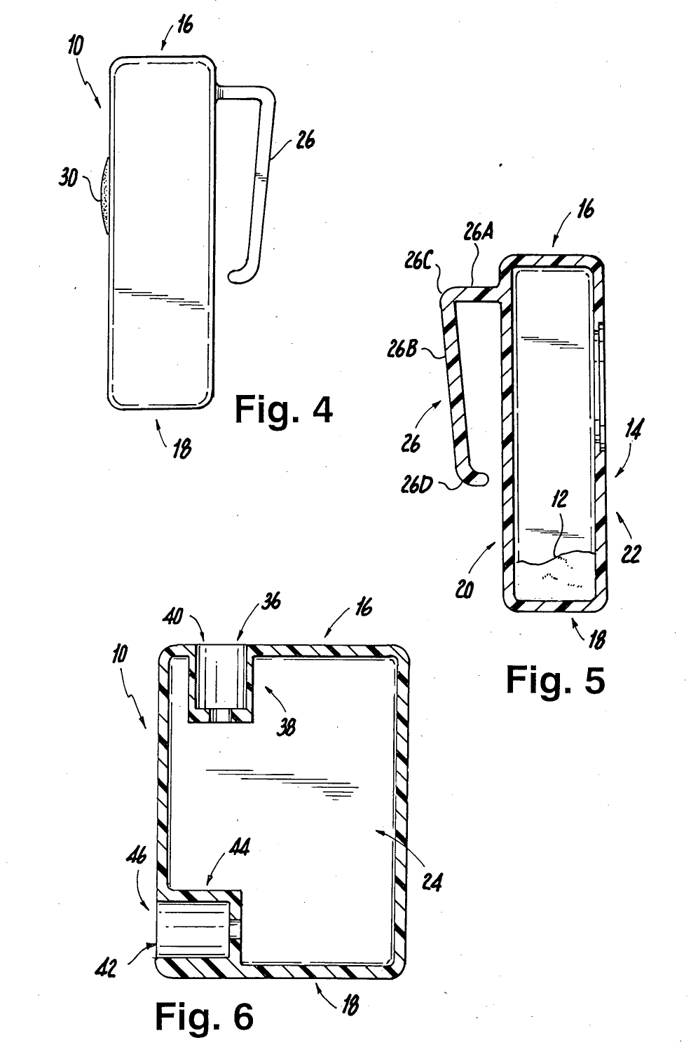

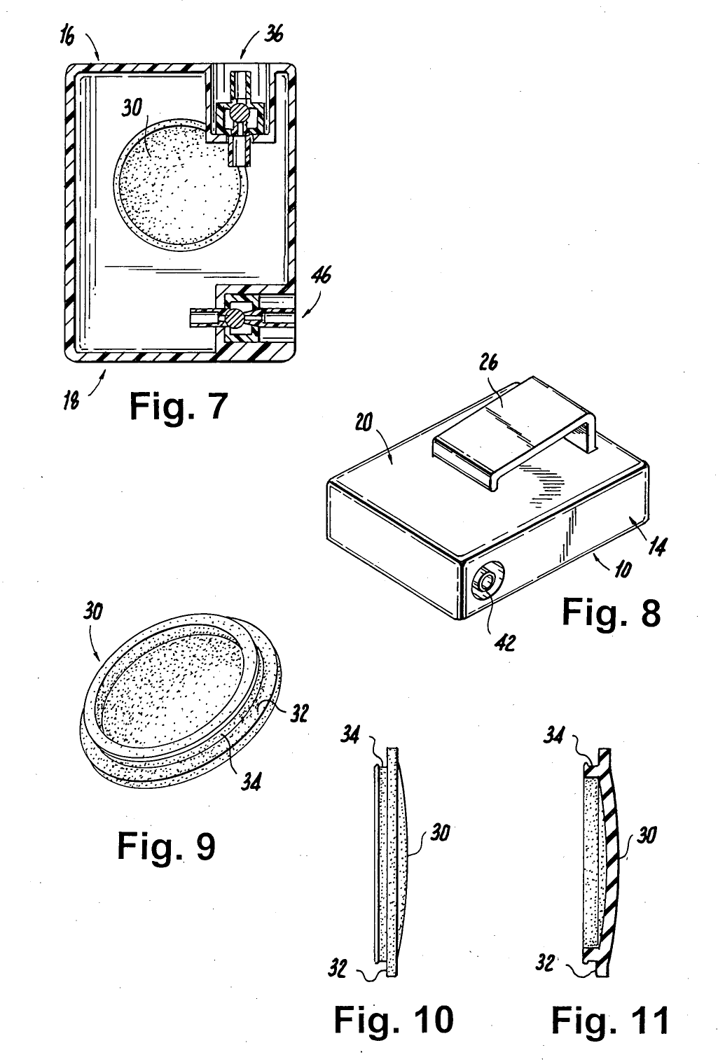

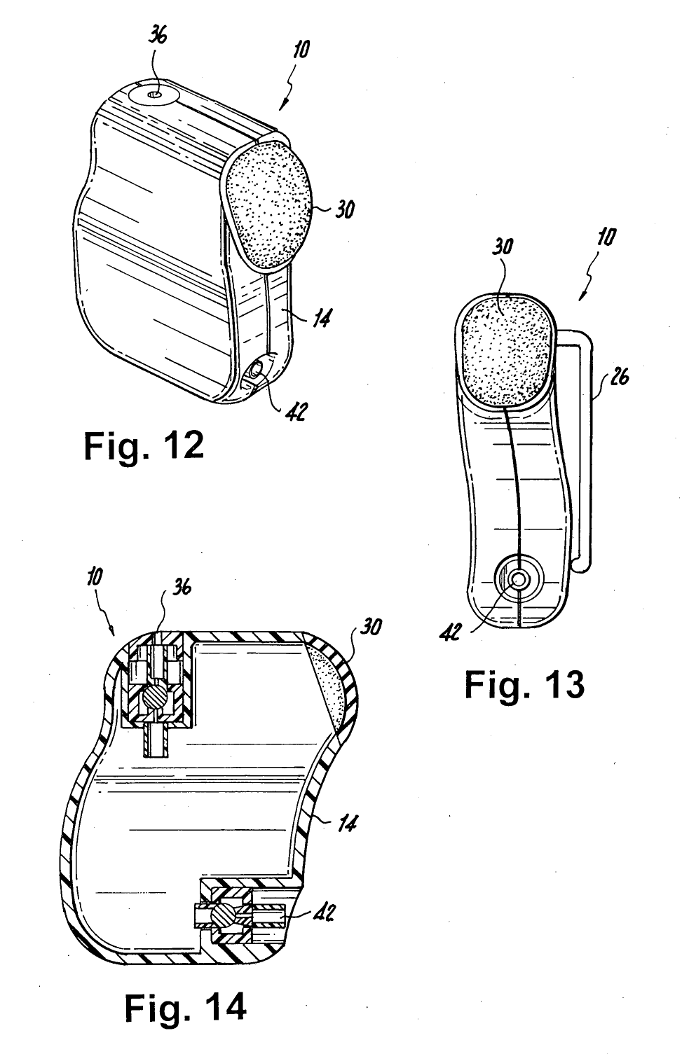

The present invention is generally set forth in FIG. 1. It is a hand sanitizing apparatus 10 for dispensing and applying a germicidal agent such as a gel, fluid, lotion, cream, ointment or liquid soap 12. It comprises a body 14, having a top end 16, a bottom end 18, a first side 20, a second side 22 and a reservoir 24.

The body 14 is of a solid, hard construction. It cannot be squeezed. It is rigid. It is not pliable, flexible or resilient. It is constructed or molded from conventional metallic or thermoplastic materials, or both, via conventional thermoplastic molding processes, such as injection molding, vacuum molding and the like. Its overall dimensions, i.e., its height, length, and width, are only limited by the application in connection with which the dispenser will be used. However, for general use by the public at large, the preferred shape and dimensions are such that they do not detract from the desired mountability, portability, and accessibility of the dispensing device, at any time or any location. Preferably, the dimensions of the device should approximate those of a relatively large, classic type “beeper” device.

The body 14 is equipped with a chamber or reservoir 24. The reservoir is designed to receive and store germicidal agents such as gels, fluids, lotions, creams, ointments or liquid soaps. The dimensions of the reservoir 24, just like the dimensions of the body, can vary from very small to quite large, depending on the application. For purposes of general use, however, the internal volume of the reservoir 24 is not more than 100 cubic centimeters, and preferably between 10 and 50 cubic centimeters. Such volume keeps the dispenser relatively small, light, easy to transport, easy to mount and capable of rapid filling and emptying. Furthermore, by virtue of its small volume and size, it maintains the dispenser's portability and mountability characteristics, even when filled to capacity with a germicidal agent, without defeating its intended use for the delivery of the germicidal agent to the end user.

The body 14, as set forth above, has a first side 20 and a second side 22. The first side 20 is provided with a mounting means 26 designed for hooking, mounting and maintaining the dispenser on anything capable of being hooked, as for example on a belt holding up a pair of trousers, on a waste band of a skirt, on a purse strap, on a bag handle, on the edge of an open bag, on the edge of a binder, of the edge of a pocket, on a carry one, etc.

The mounting means 26 can comprise a single generally L-shaped member of the same type of material as the body 14. The L-shaped member can be integrally molded as a single unitary piece with the body 14 for more strength and rigidity. Alternatively, it can be attached directly to the first side 20 of the body 14, after the body is molded. The means of attachment of the L-shaped member 26 to the body can be any suitable thermoplastic adhesive and/or heat.

As the term generally implies the L-shaped member 26 has a first arm 26A and a second arm 26B. However, the two arms 26A and 26B are not joined at a perfect right angle. Rather they are joined by a slightly rounded elbow 26C at an angle slightly less than ninety degrees.

The first arm 26A is shorter in length than the second arm 26B. It is integrally molded or attached to the first side 20 of the body by its end opposite the elbow 26C. In turn the longer arm 26B's end, which is also opposite the elbow 26C is slightly curved to form a very small radius hook 26D. The rigidity of the thermoplastic material used to form the L-shaped member 26, the length of the first arm 26A, the length of the second arm 26B, the point of attachment of the first arm 26A to the body 14 together with the elbow 26C and the less than ninety (90) degree angle formed by the first arm, the second arm and the elbow, resiliently bias the long second arm 26B towards the body 14. Such resilient bias together with the radius hook 26D work together with the body 14 to form a clipping type mechanism that is not only flexible enough to allow the mounting of the dispenser on anything with an edge, but is strong enough to allow the continued support and mobility of the dispenser anywhere.

Alternatively, the mounting means 26 does not comprise an L-shaped member. Rather it comprises a single flexible belt fixedly attached at its midpoint on the first side 20 of the body 14, thereby leaving its terminal ends free and available for mounting the dispenser anywhere the terminal ends can be wrapped and tied around. The mounting means 26 can also comprise two belts of equal length, placed end to end in series, and whose ends adjacent to each other are adhered and fixed either by glue or heat on the first side 20 of the body 14. The belts are preferably manufactured out of vinyl coated nylon, which affords extraordinary strength and flexibility. The terminal ends of the belt(s) that are free and opposite the adhesion point on the first side 20 of the body 14 can be further provided with a conventional hook and loops fastener or closure connection, such as that sold under the trademark VELCRO®. Specifically, one terminal end of the belt(s) is equipped with a first portion of the VELCRO® fastener, i.e. the hook portion, and the other terminal end of the belt(s) is equipped with the second portion of the VELCRO® fastener, i.e. the loop portion. The location of the VELCRO® portions on the terminal free ends is such that when the two belt ends are wrapped around the item on which the dispenser will be mounted, they overlap to allow the VELCRO® portions to face each other and engage to permit a mechanical interlocking which results in the holding of the dispenser in place securely, until such time as the belt ends are manually disengaged.

The belts could be of fixed length or in the alternative could be equipped with buckles capable of adjusting the belts' length. As a result, the mounting means is not only flexible but it is also adjustable and capable of allowing the inventive dispenser to be mounted and secured just about anywhere the belts can wrap around, i.e., a belt, a purse strap, a back pack strap, a pipe, a golf club, a tennis racket, bicycle handlebars, a steering wheel a baby carriage, a rail, etc. The applications are limited only by the user's imagination.

The second side 22 of the body 14 is opposite to the mounting means-bearing, first side 20. The second side 22 is provided with an orifice 28 which bores through the wall of the second side 22 and into the reservoir 24, thereby connecting and exposing the reservoir 24 to the outside. The wall thickness of the second side is not uniform. Rather, the overall thickness of the wall of the second side tapers from a larger thickness to a lesser thickness in the wall area defining the outer perimeter of the orifice 28, i.e., the diameter of the orifice 28.

Inserted into the orifice 28 and sealing the reservoir from the outside, is a dome-shaped stopper or plug 30. The stopper or plug is a one-piece, molded, relatively soft, relatively pliable rubber structure, of substantially short length. Its outer surface is substantially cylindrically shaped, having a slightly domed upper end and a lower end. At its upper domed end, the plug or stopper 30 slopes down and is tapered into a radially outwardly extending flange 32, i.e., a rim. Below the rim, between the plug's rim and the plug's lower end, the plug bears a groove, a notch or a channel 34. Alternatively, the lower end of the plug may be provided with a molded bead which then serves to define a notch or a groove between it and the rim. As the bottom end of the plug is pushed through the orifice, the tapered edge of the second side wall forming the outer diameter of the orifice 28 slips into the notch or groove or channel snap fitting the plug into the orifice and locking it into place to effectively seal the reservoir. The bottom side of the plug's rim in turn couples with the tapered-wall, orifice-diameter-defining edge of the second side 22 such that the rim and the wall are flush with each other further effectively sealing the reservoir. However, in view of the fact that the plug is slightly domed, the plug now forms a button on the outer surface of the second side 22 that is still easy to feel and because of its pliability it is easy to press. It is this pressure that serves to force the germicidal agent out of the dispenser. It must be noted that while the plug is sufficiently resilient so as to allow the dispensing of the germicidal agent, it is still sufficiently rigid as to prevent the accidental release of the agent when the plug-or button is accidentally or unintentionally actuated.

In addition to the first and second sides, the body 14 also has a top end 16 and a bottom end 18. The top end is equipped with an entry port 36 comprising a recessed integrally molded, cylindrical partial bore 38 and a filling or intake valve 40. The bore has an upper, open end and a lower closed end. The bore extends into the body 14 vertically, i.e., along a y-axis, and protrudes right into the reservoir 24. However because it is only a partial bore, i.e. its lower end is closed, it does not expose the reservoir to the outside. Rather its closed lower end acts as a receiving base for the mounting of the filling or intake valve 40. The filling or intake valve 40 is the only means by which the reservoir 24 can be refilled with germicidal agent. Preferably, the valve has a nozzle which extends upward from the lower closed end of the cylindrical bore but not above the upper open end of the bore; certainly not beyond the upper surface of the top end 16. The germicidal agent 12 is introduced into the reservoir 24 through this filling valve 40. It is introduced via a specially made nozzle which can be connected to a gel supply container on the one hand and fitted and coupled to the filling or intake valve 40 on the other. As pressure is applied to squeeze the supply container, the germicidal agent 12 flows from the supply container into the reservoir 24. When the reservoir 24 is filled and the supply bottle with its accompanying nozzle is disengaged and removed from the filling valve 40, the germicidal agent is prevented from flowing out of the entry port 36 by virtue of the physical, “check valve” characteristics of the filling or intake valve 40. Preferably, the valve used in the germicidal dispenser is a silicone valve having an ABS housing, an outer diameter of 0.124″ at both ends and capable of withstanding a CP of up to 0.142 psi.

The side wall of the bottom end 18 is equipped with an exit port 42 comprising a second, recessed, integrally molded, cylindrical partial bore 44 and an output or exit valve 46. The bore has a first, open end and a second closed end. The bore extends along the body horizontally, i.e. along an x-axis, extending and protruding right into the body's reservoir 24. However, because it is an incomplete or partial bore, i.e., its second end is closed, it does not expose the reservoir to the outside. Rather, its closed second end acts as a receiving base for the mounting of the output or exit valve 46.

The output or exit valve 46 is the only means by which the reservoir 24 can be emptied. The output or exit valve 46 has a nozzle which extends horizontally from the second closed end of the cylindrical bore but stays below the first open end of the bore; certainly does not extend beyond the outer surface of the side wall of the bottom end 18. The germicidal agent exits the reservoir 24 through the output valve when the plug or button 30 is pressed. As the germicidal agent is pushed out the exit valve 46, air is pulled into the reservoir 24 through the intake valve 40 to fill the void left behind by the dispensed gel, thereby making the dispensing easy and smooth. When the germicidal agent is dispensed, the germicidal agent is prevented from flowing out of the exit port, by virtue of the physical, “check valve” characteristics of the output or exit valve 46.

Preferably the output or exit valve 46 used in the germicidal dispenser is a silicone valve having a PC housing, capable of fitting 0.105″ O.D. tubing at both ends and capable of withstanding a CP of up to 0.433 psi.

The method of using the inventive dispenser set forth above comprises the following steps: (a) filling the reservoir of the dispenser with a germicidal agent such as gels, fluids, lotions, creams, ointments or liquid soaps using the filling or intake valve on the top end of the body; (b) mounting and securing the dispenser on a belt, a bag, a folder, etc; (c) carrying the dispenser to whatever site the dispenser may be needed; (d) if and when the germicidal agent is needed, pressing on the plug button to deliver a predetermined dosage of gel, i.e., 1 to 2 cc; and (e) rubbing hands together to distribute the germicidal agent all over the surface of the hands, in order for the gel to kill the bacteria and evaporate leaving a clean feeling on the hands.

An alternate embodiment of the inventive dispenser described here in above is generally set forth in FIGS. 16 through 26. As can be seen from the figures the only difference between the first embodiment described here in above and the second alternate embodiment set forth in Figures is the shape and location of both the orifice 28 and the dome-shaped stopper or plug 30.

In the alternate embodiment the orifice is not located on the second side 22 of the body 14. Rather, the orifice is found at the top end 16 of the body 14, opposite the entry port 36. The alternate embodiment's orifice 28 bores through the wall of the top end 16 and into the reservoir 24, thereby connecting and exposing the reservoir 24 to the outside. Furthermore, the overall thickness of the wall of the top end 16 tapers from a larger thickness to a lesser thickness in the wall area defining the outer perimeter of the orifice 28, i.e., the diameter of the orifice 28.

Inserted into the orifice 28 and sealing the reservoir from the outside, is a dome-shaped stopper or plug 30. The stopper or plug is a one-piece, molded, relatively soft, relatively pliable rubber structure, of substantially short length. Its outer surface is shaped to accommodate its location on the top end 16, having a slightly domed upper end and a lower end. At its upper domed end, the plug or stopper 30 slopes down and is tapered into a radially outwardly extending flange 32, i.e., a rim. Below the rim, between the plug's rim and the plug's lower end, the plug bears a groove, a notch or a channel 34. Alternatively, the lower end of the plug may be provided with a molded bead which then serves to define a notch or a groove between it and the rim. As the bottom end of the plug is pushed through the orifice, the tapered edge of the second side wall forming the outer diameter of the orifice 28 slips into the notch or groove or channel snap fitting the plug into the orifice and locking it into place to effectively seal the reservoir. The bottom side of the plug's rim in turn couples with the tapered-wall, orifice-diameter-defining edge of the second side 22 such that the rim and the wall are flush with each other further effectively sealing the reservoir. However, in view of the fact that the plug is slightly domed, the plug now forms a button that extends beyond the outer surface of the top end 16 that is still easy to feel and because of its pliability it is easy to press. It is this pressure that serves to force the germicidal agent out of the dispenser. It must be noted that while the plug is sufficiently resilient so as to allow the dispensing of the germicidal agent, it is still sufficiently rigid as to prevent the accidental release of the agent when the plug or button is accidentally or unintentionally actuated.

The embodiments described above are provided by way of illustration only and should not be construed to limit the invention. Those skilled in the art, both within and without the area of food preparation and serving, will readily recognize various modifications and changes, which may be made to the present invention without strictly following the exemplary embodiments and applications illustrated and described herein and without departing from the true scope of the present invention, which is set forth in the following claims.

What is claimed is:

1. A liquid or gel dispensing apparatus, which comprises a reservoir housed within the liquid or gel dispensing apparatus for the receipt and storage of the liquid or gel, and a plug inserted into the liquid or gel dispensing apparatus and communicatingly connected to said reservoir whereby the stored liquid or gel is released and dispensed out of the liquid or gel dispensing apparatus when said plug is intentionally actuated.

2. The liquid or gel dispensing apparatus of claim 1, wherein the liquid or gel dispensed is a germicidal agent.

3. The liquid or gel dispensing apparatus of claim 1, wherein said reservoir has an internal volume of not more than 100 cubic centimeters.

4. The liquid or gel dispensing apparatus of claim 1, wherein said reservoir has an internal volume of 10 to 50 cubic centimeters.

5. The liquid or gel dispensing apparatus of claim 1, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks into place.

6. The liquid or gel dispensing apparatus of claim 2, wherein said reservoir has an internal volume of not more than 100 cubic centimeters.

7. The liquid or gel dispensing apparatus of claim 2, wherein said reservoir has an internal volume of 10 to 50 cubic centimeters.

8. The liquid or gel dispensing apparatus of claim 2, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks into place.

9. The liquid or gel dispensing apparatus of claim 3, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks into place.

10. The liquid or gel dispensing apparatus of claim 4, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks into place.

11. A liquid or gel dispensing apparatus, which comprises mounting means fixedly attached on the liquid or gel dispensing apparatus and designed for mounting the liquid or gel dispensing apparatus on anything capable of being hooked, a reservoir housed within the liquid or gel dispensing apparatus for the receipt and storage of the liquid or gel and a plug communicatignly connected to said reservoir whereby the stored liquid or gel is released and dispensed when the plug is intentionally actuated.

12. The liquid or gel dispensing apparatus of claim 11, wherein the liquid or gel dispensed is a germicidal agent.

13. The liquid or gel dispensing apparatus of claim 11, wherein said mounting means comprises a single generally L-shaped member integrally molded to the liquid or gel dispensing apparatus to form as a single unitary piece.

14. The liquid or gel dispensing apparatus of claim 12, wherein said mounting means comprises a single generally L-shaped member integrally molded to the liquid or gel dispensing apparatus to form as a single unitary piece.

15. The liquid or gel dispensing apparatus of claim 11, wherein said mounting means comprises a single L-shaped member fixedly attached to the liquid or gel dispensing apparatus.

16. The liquid or gel dispensing apparatus of claim 12, wherein said mounting means comprises a single L-shaped member fixedly attached to the liquid or gel dispensing apparatus.

17. The liquid or gel dispensing apparatus of claim 13, wherein the L-shaped member has a first arm and a second arm said first and second arms joined by a slightly rounded elbow at an angle of slightly less than ninety degrees.

18. The liquid or gel dispensing apparatus of claim 13, wherein said mounting means comprises a single flexible belt fixedly attached at its midpoint on the liquid or gel dispensing apparatus thereby leaving its terminal ends free and available for mounting the apparatus anywhere the terminal ends can be wrapped and tied around.

19. The liquid or gel dispensing apparatus of claim 11, wherein said mounting means comprises two belts of equal length, placed end to end in series, and whose ends adjacent to each other are fixed attached to the liquid or gel dispensing apparatus.

20. The liquid or gel dispensing apparatus of claim 12, wherein said mounting means comprises two belts of equal length, placed end to end in series, and whose ends adjacent to each other are fixed attached to the liquid or gel dispensing apparatus.

21. The liquid or gel dispensing apparatus of claim 11, wherein said reservoir has an internal volume of not more than 100 cubic centimeters.

22. The liquid or gel dispensing apparatus of claim 11, wherein said reservoir has an internal volume of 10 to 50 cubic centimeters.

23. The liquid or gel dispensing apparatus of claim 11, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks it into place.

24. The liquid or gel dispensing apparatus of claim 12, wherein said reservoir has an internal volume of not more than 100 cubic centimeters.

25. The liquid or gel dispensing apparatus of claim 12, wherein said reservoir has an internal volume of 10 to 50 cubic centimeters.

26. The liquid or gel dispensing apparatus of claim 12, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks it into place.

27. The liquid or gel dispensing apparatus of claim 3, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks it into place.

28. The liquid or gel dispensing apparatus of claim 4, wherein said plug further comprises a one-piece, molded, pliable, dome-shaped rubber stopper of substantially short length having a radially outwardly extending flange and a groove whereby when inserted into the liquid or gel dispensing apparatus it snap-fits and locks it into place.

29. A hand sanitizing apparatus for dispensing a germicidal agent, comprising:
(a) a body having a top end, a bottom end, a first side, a second side and an orifice;
(b) mounting means fixedly attached to said first side of said body, and designed for hooking, mounting and maintaining the hand sanitizing apparatus on anything capable of being hooked;
(c) an entry port fixedly located on said top end;
(d) an exit port fixedly located on said bottom end;
(e) a reservoir housed within said body for the receipt of the germicidal agent, through said entry port, and storage of the germicidal agent; and
(f) a dome-shaped plug inserted into said orifice of said body and communicatingly connected to said reservoir, whereby the stored germicidal agent is released and dispensed through said exit port when the plug is intentionally actuated.
